(19) United States
(12) Patent Application Publication
(10) Pub. No.: US 2012/0116671 A1
(43) Pub. Date: May 10, 2012

(54) SYSTEM FOR PROVIDING POINT OF INTEREST INFORMATION AND METHOD THEREOF

(75) Inventors: Bum Tae Lee, Goyang (KR); Sung Wook Heo, Yongin (KR); Chi Nam Oh, Suwon (KR); Min Suk Kim, Yongin (KR); Young Eon Ma, Ulsan (KR)

(73) Assignees: KIA MOTORS CORPORATION, Seoul (KR); HYUNDAI MOTOR COMPANY, Seoul (KR)

(21) Appl. No.: 13/053,824

(22) Filed: Mar. 22, 2011

(30) Foreign Application Priority Data
Nov. 9, 2010 (KR) 10-2010-0111058

(51) Int. Cl. G01C 21/00; G06F 17/30

(52) U.S. Cl. 701/426; 707/600; 707/E17.014; 701/438

(57) ABSTRACT

Provided is a system for providing point of interest (POI) information includes a database configured to store the POI information corresponding to a name and identification information of each POI; a data communication module configured to extract the name and the identification information of the POI, which is extracted from a particular website by a first terminal and stored in a user designated path; and a control module configured to extract, from the database, the POI information corresponding to the name and the identification information of the POI extracted by the data communication module and transmit the POI information to the first terminal or a second terminal that is pre-defined.

### CROSS-REFERENCES TO RELATED APPLICATIONS

Priority to Korean patent application number 10-2010-0111058, filed on Nov. 9, 2010, which is hereby incorporated by reference in its entirety, is claimed.

### BACKGROUND OF THE INVENTION

1. Field of the Invention

The present invention relates to a method and a system for providing information of a point of interest (POI) to a user terminal through a website.

2. Description of the Related Art

In general, a navigation system is used for a user to view a driving route to a destination from departure. Such navigation systems allow a user to create a point of interest (POI), i.e., a frequently visited place, on an electric map of the navigation system. For example, information of the POI can be added to a particular location on the electric map.

However, in conventional navigation systems a particular POI listed in a website cannot be imported to the navigation system. Thus, it must be entered manually.

### SUMMARY OF THE INVENTION

The present invention provides a system and a method for providing point of interest (POI) information in which a name and identification information of a particular point of interest may be extracted and analyzed from a user designated path of a particular website to extract and transmit the POI information to a user designated terminal, thereby utilizing the POI information for route calculation within a navigational system of a vehicle.

In accordance with an embodiment of the present invention, a system for providing point of interest (POI) information comprises a database configured to store the POI information corresponding to a name and identification information of each POI; a data communication module configured to extract the name and the identification information of the POI from a particular website by a first terminal and stored in a user designated path; and a control module configured to extract, from the database, the POI information corresponding to the name and the identification information of the POI extracted by the data communication module and transmit the POI information to either the first terminal or a second terminal depending upon which terminal is pre-defined.

The present invention also provides a method for utilizing point of interest (POI) information defined within a website on the internet. Specifically, name and identification information of the POI is extracted from a user designated path. This name and identification information is extracted from a particular website by a first terminal and stored in the user designated path. Then, the POI information, is extracted from a database. This POI information corresponding to the name and the identification information of the POI extracted from the user designated path. Subsequently, the POI information is transmitted to either the first terminal or a second terminal depending on which terminal is pre-defined.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a network for providing point of interest (POI) according to an exemplary embodiment of the present invention;

FIG. 2 is a block diagram illustrating a configuration of a system for providing POI according to an exemplary embodiment of the present invention;

FIG. 3 is a block diagram illustrating a configuration of a website server according to an exemplary embodiment of the present invention;

FIG. 4 is a block diagram illustrating a configuration of a terminal according to an exemplary embodiment of the present invention; and

FIG. 5 is a flowchart diagram illustrating a method of providing POI according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

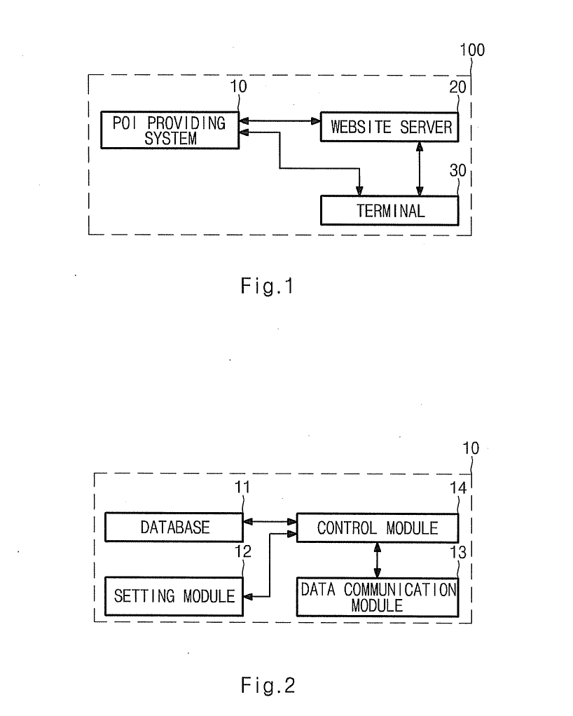

FIG. 1 is a block diagram illustrating a configuration of a network 100 for providing point of interest (POI) according to the present invention.

As shown in FIG. 1, the POI providing network 100 according to the present invention includes a POI providing system 10, a website server 20, and a terminal 30.

The POI providing system 10, as shown in FIG. 2, includes a database 11 for storing POI information, which corresponds to a name and identification information of a particular POI. The POI providing system 10 receives the name and the identification information of the POI, which is extracted from a particular website and stored in a user designated path. The POI providing system 10 then extracts POI information from the database 11 using the received name and identification information of the POI.

The POI providing system 10 transmits the extracted POI information to the terminal 30. Here, the terminal 30 includes a first terminal through which a user is currently connected to the POI providing system 10 or a second terminal separately designated by the user. The first terminal or the second terminal can calculate a route to a location for the POI information. The website server 20 may provide the first terminal, which is connected thereto, names of POIs of various kinds, a website having a web page that contains identification information of each POI, and the user designated path, e.g., “my folder,” which allows the user to temporarily save the name and the identification information of the POI.

In the exemplary embodiment of the present invention, the terminal 30 may store the name and the identification information of the POI extracted from the particular website in the user designated path. Meanwhile, the terminal 30 may receive the POI information corresponding to the name and the identification information of the POI from the POI providing system 10 so that a route may be calculated to the POI as a destination.

Hereinafter, the POI providing network 100 according to the present invention is described in detail with respect to each element thereof.

### Configuration of the POI Providing System 10—

FIG. 2 is a block diagram illustrating a configuration of a system 10 for providing point of interest information according to an exemplary embodiment of the present invention.

The POI providing system 10, shown in FIG. 2, includes a database 11, a setting module 12, a data communication module 13, and a control module 14.

The database 11 may be used to store the POI information corresponding to the name and the identification information of the particular POI. For example, the POI may refer to a building or a store shown on an electrical map. This POI can also be selectively displayed according to a paid request by an owner of the building or the store, popularity of the building and the store (i.e., frequently visited by general public) or a setting by an electrical map manufacture.

Here, the POI information includes a name, picture information, a position coordinate and detailed information of the POI. Meanwhile, the POI identification information includes at least one of a telephone number or an address of the POI, or a domain address of the particular website associated with the POI.

The setting module 12 may be used to receive an address of the user designated path and information of the first terminal or the second terminal from a user through the first terminal. Namely, when a user visits the particular website while using the first terminal or the second terminal with an internet connectivity, the user can select the name and the identification information of the POI, i.e., a location of interest, by way of, for example, a drag or copy operation. Then, the setting module 12 saves the name and the identification information of the selected particular POI in the user designated path in a form of text (list updating). Here, the “user designated path” implies a feature similar to the myfolder provided by the particular website, for example, www.naver.com, which enables the user to write and save certain information in the form of text (list). Thus, the “user designated path” may have its own web page address (connection path).

The setting module 12 may then receive, from the first terminal, information including a telephone number, an IP address, or a MAC address of the second terminal to which the POI information is transmitted. Alternatively, the first terminal can be set to receive the POI information, and the control module 14 can transmit the POI information to the second terminal with ease by using the address of the second terminal.

Here, when the terminal 30 for receiving the POI information is set as the first terminal by the user through the setting module 12 the following is meant: the user can connect to the particular website through the first terminal, e.g., a navigation terminal, to save the name and the identification information of the particular POI in the user designated path and receive the POI information corresponding to the name and the identification information of the particular POI through the first terminal.

Alternatively, when the terminal 30 for receiving the POI information is set as the second terminal by the user through the setting module 12, has the following meant: the user can connect to the particular website through the first terminal, e.g., the navigation terminal, to store the name and the identification information of the particular POI in the user designated path and receive the POI information corresponding to the name and the identification information of the particular POI through the second terminal, e.g., an automotive head unit or the navigation terminal.

The data communication module 13 is configured to extract the name and the identification information of the POI, which is periodically extracted from the particular website and stored in the user designated path, by using the address of the user designated path (i.e., the web page address of its own).

Furthermore, the control module 14 may extract the POI information from the database 11 by using the name and the identification information of the POI extracted through the user designated path. The control module 14 transmits the extracted POI information to the first terminal or the second terminal. For example, it is assumed that the user visits the particular website, for example, www.naver.com, by using the first terminal and locates information “for the best quality beef, Son-Soo-Hun at Chung Dam Dong, Boiled Cow Intestines, 42,000 won for Dinner, Yellow Corvina 42,000 won for Lunch, Location=Hak Dong 215, Gang Nam Gu, Telephone: (02) 3442-2567-8.”

In this example, the name of the POI is Son-Soo-Hun, the identification information of the POI is the address of the website or the telephone of a restaurant, and a user can drag and copy the name and the identification information of the POI by using the key input module 32 of the first terminal to be sent to the website server 20. The website server 20 can update a list in the user designated path with the dragged and copied content.

In some situations, when only the name of the POI and the address of the particular website which contains the name of the POI are saved in the user designated path, it may be difficult for the control module 14 to differentiate the POI from another POI having the same name. In this case, the control module 14 may transmit the name and a domain address of the POI to a website server. The control module 14 then receives from the website server 20 the identification information of the POI or the POI information corresponding to the name of the POI extracted by the website server 20 from property information of the website that corresponds to the domain address of the POI.

Furthermore, when the first terminal or the second terminal is a head unit installed in a vehicle, the control module 14 identifies whether the vehicle is started, and when it is determined that the vehicle is started, the control module 14 transmits the POI information to the first terminal or the second terminal depending upon which terminal has been pre-defined.

### Configuration of the Website Server 20

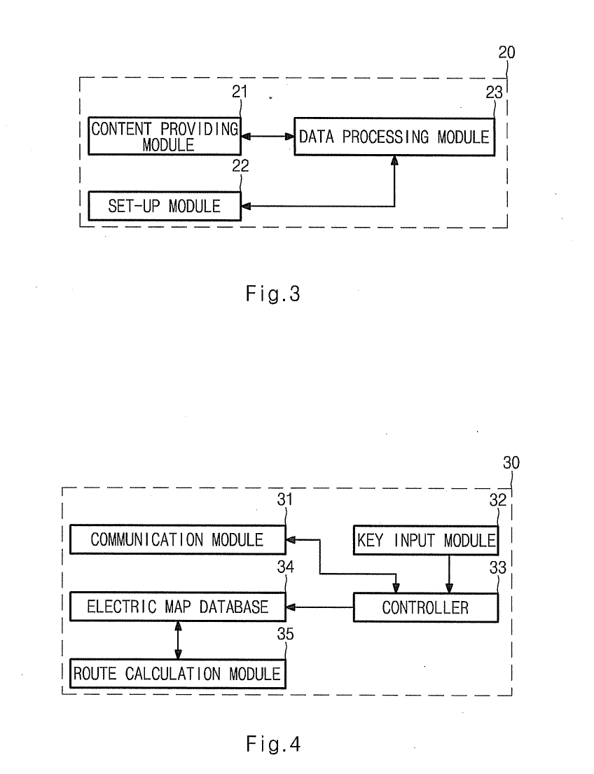

FIG. 3 is a block diagram illustrating a configuration of the website server 20 according to an exemplary embodiment of the present invention.

The website server 20 includes a content providing module 21, a set-up module 22, and a data processing module 23.

The content providing module 21 provides various web pages having various contents such as news, stock information, or a web page that include the name and the identification information of the POI to the first terminal. Here, the name and the identification information of the POI or the POI information is inserted into a header of the web page as property information.

For example, if a particular news article file includes restaurant A and restaurant B but does not include identification information of the restaurant A and the restaurant B, the person who registers the content places a record of the identification information (e.g., an address, a phone number or the POI information) of the restaurant A and the restaurant B in a header of the news article file as property information and registers the news article file with the website server 20. The data processing module 23, which will be described below, of the website server 20 can then identify the address, the telephone number or detailed information corresponding to the name of the POI once a web page address of the news article file and the name of the POI are obtained.

The set-up module 22 is configured to receive from the first terminal a request for the user designated path in which the name and the identification information of the POI are to be recorded. This set-up module 22 establishes the user designated path by using a general technique of creating a web folder and transmitting an address of the established user designated path (the web page address of its own) to the first terminal. The data processing module 23 then receives the name of the POI and an address of the particular website which contains the name of the POI from the POI providing system 10. Subsequently, the data processing module 23 extracts the identification information of the POI or the POI information, which corresponds to the name of the POI by using the property information included in the header of the web page corresponding to the address of the particular website.

The data processing module 23 then transmits the extracted identification information of the POI or the POI information to the POI providing system 10. Thus, when the data processing module 23 receives from the first terminal a request to store the name and the identification information of the POI in the user designated path (folder), the data processing module 23 stores the name and the identification information of the POI in the user designated path (folder) that corresponds to the first terminal.

### Configuration of the Terminal 30

FIG. 4 is a block diagram illustrating a configuration of the terminal 30 according to exemplary embodiment of the present invention.

As shown in FIG. 4, the terminal 30 includes a first terminal, which extracts the name and the identification information of the POI from the particular website to be saved in the user designated path, and a second terminal, which receives the POI information from the POI providing system 10.

Here, the first terminal and the second terminal have the same configuration. Hereinafter, the first terminal and the second terminal are referred to as the terminal 30 and so are not distinguished.

The terminal 30 may include a communication module 31, a key input module 32, a controller 33, an electric map database 34, and a route calculation module 35.

The communication module 31 connects to the website server 20 by using a predefined communication protocol and receives various web pages such as news, stock information, or a web page from the website server 20.

The key input module 32 receives a request for the user designated path from the user during when the various contents are received from the website server 20.

The key input module 32 of the first terminal allows the user to select the name and the identification information of the POI during when various content is received from the website server 20. Additionally, this key input module 32 allows the user to set/pre-define the information of the terminal (the first terminal or the second terminal) through which the POI information is to be received.

The controller 33 transmits the request for the user designated path received through the key input module 32 to the website server 20 and receives the address of the user designated path (the web page address of its own) from the website server 20. The controller 33 transmits, to the POI providing system 10, the address of the user designated path and information of the terminal through which the POI information is to be received. The controller 33 requests the POI providing system 10 to store the name and the identification information of the POI received from the user in the user designated path during when the various contents are received from the website server 20 through the key input module 32. The controller 33 also receives the POI information corresponding to the name and the identification information of the POI from the POI providing system 10 to reflect to the electric map database 34.

The electric map database 34 is used to store an electrical map, the name and identification information of the particular POI represented in the electrical map, and the POI information. In such an electric map database 34, the POI information corresponding to the name and the identification information of the POI is periodically reflected by the controller 33.

The route calculation module 35 provides a user route calculation from departure to a destination by using a well known map matching method based on the electrical map database 34 in which the POI information corresponding to the name and the identification information of the POI received from the POI providing system 10 is reflected.

Hereinafter, a method of providing the POI according to the present invention is described.

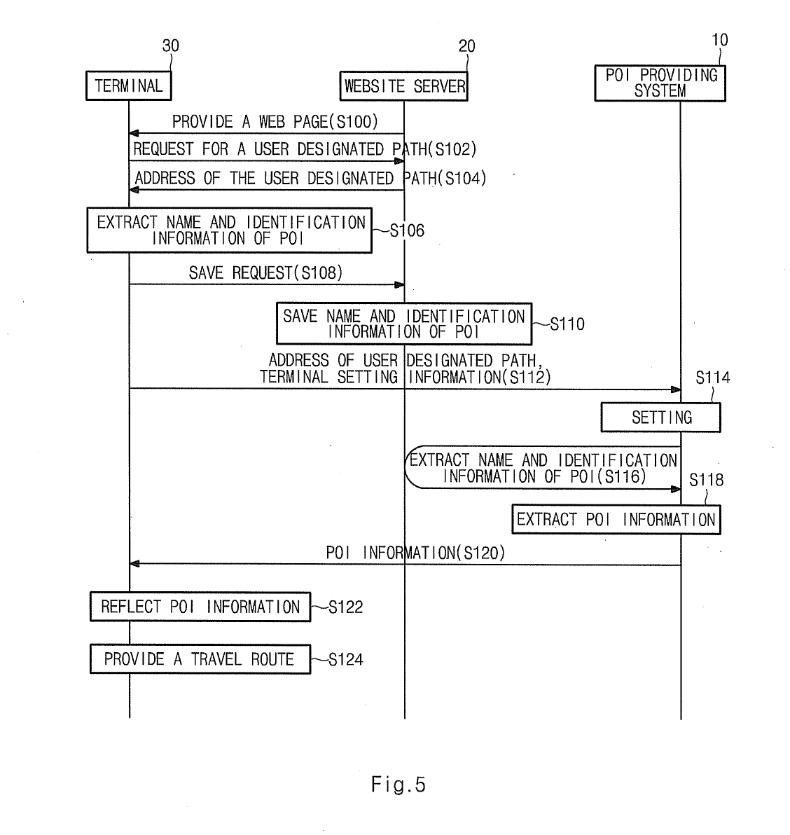

FIG. 5 is a flowchart diagram illustrating a method of providing the POI information according to an exemplary embodiment of the present invention.

Initially, the first terminal is connected to a web page provided by the website server 20 by using the communication module 31 to receive various web pages such as news, stock or web page from the website server 20 (S100).

Next, the key input module 32 of the first terminal receives a request for a user designated path from a user of the website and transmits the request to the website server 20 (S102). The set-up module 22 of the website server 20 then establishes the user designated path and transmits a message to the first terminal notifying the first terminal that a successful establishment of the user designated path and the address (web page address) of the user designated path has been established (S104).

Next, the key input module 32 of the first terminal allows the user to select the name and the identification information of the POI during when various content is received from the website server 20 (S106). Then, the controller 33 of the first terminal extracts the name and the identification information of the POI selected by the user from the various contents through the key input module 32 and requests the POI providing system 10 store the extracted name and the identification information of the POI in the user designated path (S108).

Subsequently, the data processing module 23 of the website server 20 stores the name and the identification information of the POI in the user designated path corresponding to the first terminal (S110), and the controller 33 of the first terminal transmits the address of the user designated path and setting information of a terminal, which is set by the user through the key input module 32 to receive the POI, e.g., the second terminal, to the POI providing system 10 (S112).

The setting module 12 of the POI providing system 10 then receives the address of the user designated path and the information of the second terminal, which is the terminal 30 for receiving the POI, to set the user designated path and set the terminal 30 as the second terminal (S114).

Next, the data communication module 13 of the POI providing system 10 periodically connects to the user designated path by using the address of the user designated path to extract the name and the identification information of the POI saved in the user designated path (S116).

Next, the control module 14 of the POI providing system 10 extracts the POI information from the database 11 by using the name and the identification information of the POI extracted from the user designated path (S118), and transmits the extracted POI information to the terminal 30 for receiving the POI, i.e., the second terminal (S120).

The controller 33 of the second terminal receives the POI information corresponding to the name and the identification information of the POI from the POI providing system 10 and reflects the POI information in the electrical map database 34 (S122).

In doing so, the route calculation module 35 of the second terminal can calculate a travel route from a departure to a destination by using the electrical map database 34 in which the POI information is reflected and a general map matching method and provides the calculated travel route to the user (S124).

Advantageously, in the present invention, the POI information can be extracted by extracting and analyzing the name and the identification information of the particular POI saved by the user in the user designated path and the extracted POI information can be transmitted to a terminal set by the user for use in route calculation, so that the user can conveniently select the point of interest in the user designated path of the particular website on the user's vehicle navigation system which may be incorporated into the vehicle. Alternatively, the user can directly input the name, photo, detailed information or position location of the POI, thereby obviating a need to create the POI on the website.

Further, in the present invention, once the name and the identification information of the particular POI are dragged and/or copied to the user designated path on the particular website, the POI information can be downloaded on a designated terminal to be incorporated into the vehicle POI system. Thus, the user can conveniently download the POI information on the web page by using only the name, telephone number or address of the POI or the domain address of the particular website.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for providing point of interest (POI), the system comprising:
a database configured to store the POI information corresponding to a name and identification information of each POI;
a data communication module configured to extract the name and the identification information of the POI, which is extracted from a particular website by a first terminal and stored in a user designated path; and
a control module configured to extract, from the database, the POI information corresponding to the name and the identification information of the POI extracted by the data communication module and transmit the POI information to either the first terminal or a second terminal depending on which terminal is pre-defined.

2. The system of claim 1, wherein the identification information of the POI includes at least one of a telephone number or an address of the POI or a domain address of the particular website.

3. The system of claim 2, wherein, when the identification information of the POI is the domain address of the particular website, the control module transmits the name of the POI and the domain address to the website server and receives the identification information of the POI or the POI information that corresponds to the name of the POI from the website server.

4. The system of claim 1, wherein the POI information includes a name, photo information, a position coordinate and detailed information of the POI.

5. The system of claim 1, wherein the first terminal or the second terminal is associated with a vehicle, and the control module identifies whether the vehicle is being operated to transmit the POI information to the first terminal or the second terminal when the vehicle is being operated.

6. The system of claim 1, wherein the name and the identification information of the POI are recorded in a form of text and stored in the user designated path.

7. The system of claim 1, further comprising a setting module configured to receive an address of the user designated path and information of the second terminal from a user.

8. A method of providing point of interest (POI) information, the method comprising:
(a) extracting, from a user designated path, a name and identification information of the POI, which is extracted from a particular website by a first terminal and stored in the user designated path;
(b) extracting the POI information, from a database, corresponding to the name and the identification information of the POI extracted from the user designated path; and
(c) transmitting the POI information to either the first terminal or a second terminal depending on which terminal is pre-defined.

9. The method of claim 8, wherein the first terminal or the second terminal is associated with a vehicle, and step (c) comprises,
identifying whether the vehicle is being operated to transmit the POI information to the first terminal or the second terminal when the vehicle is being operated.

10. The method of claim 8, further comprising, before step (a),
(a-1) receiving an address of the user designated path and information of the second terminal from a user.

11. The method of claim 8, wherein the name and the identification information of the POI are recorded in a form of text and stored in the user designated path.

12. The method of claim 8, wherein, when the identification information of the POI is a domain address of the particular website, step (a) comprises,
(a-1) transmitting the name of the POI and the domain address to the website server; and
(a-2) receiving the identification information of the POI or the POI information corresponding to the name of the POI from the website server.

13. A method of providing point of interest (POI) information, the method comprising:
extracting and analyzing POI information relating to name and identification information associated with a particular point of interest (POI) saved by a user in a user designated path which is extracted from a particular website;
transmitting to a terminal set by the user for use in route calculation of the user's vehicle navigation system, the POI information extracted from the user designated path;
selecting, by the user on a display, the transmitted POI which is associated with a user designated path associated with a particular website on the user's vehicle navigation system; and
calculating a route to the POI based on the information received from the user designated path.
